(19) United States
(12) Patent Application Publication
(10) Pub. No.: US 2009/0102089 A1
(43) Pub. Date: Apr. 23, 2009

(54) Epoxy Formulations for Use in Lithography Techniques

(76) Inventors: Wei Chen, Midland, MI (US); Brian Robert Harkness, Midland, MI (US); Sina Maghsoodi, Midland, MI (US); James Steven Tonge, Sanford, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 12/087,081

(22) PCT Filed: Jan. 23, 2007
(86) PCT No.: PCT/US2007/002034

§ 371 Date: Nov. 18, 2008

Related U.S. Application Data
(60) Provisional application No. 60/762,185, filed on Jan. 25, 2006.

(51) Int. Cl. B29C 33/40

(52) U.S. Cl. 264/225

(57) ABSTRACT

A method for preparing a patterned feature includes the steps of I) casting a curable silicone composition against a master, II) curing the curable silicone composition to form a silicone mold, II) separating the master and the silicone mold, IV) filling a silicone mold having a patterned surface with a curable epoxy formulation; V) curing the curable epoxy formulation to form a patterned feature; VI) separating the silicone mold and the patterned feature; optionally VIII) etching the patterned feature; optionally IX) cleaning the silicone mold; and optionally X) repeating steps IV) to IX) reusing the silicone mold.

### CROSS REFERENCE

This application claims the benefit of U.S. Provisional Patent Application Ser. No. 60/762,185 filed on 25 Jan. 2006. U.S. Provisional Patent Application Ser. No. 60/762,185 is hereby incorporated by reference.

### TECHNICAL FIELD

This invention relates to a method using a curable epoxy formulation with a silicone mold. The method finds use in various lithography techniques.

### Problems to be Solved

There is a need to improve lithography techniques to provide multiple and accurate patterned features from high aspect ratio features on silicone molds. There is a need to provide a method for molding high aspect ratio features from silicone molds with curable epoxy formulations.

### Means for Solving the Problems

Curable epoxy formulations may be cured with high resolution of the mold pattern by using a UV cure mechanism or a combination of UV and thermal cure mechanisms.

### SUMMARY

This invention relates to a curable epoxy formulation comprising (a) an epoxy-functional compound, and (b) a photoacid generator a photosensitizer, or a combination thereof. The curable epoxy formulation is useful in a method comprising: A) filling a silicone mold having a patterned surface with the curable epoxy formulation; B) curing the curable epoxy formulation to form a patterned feature; C) separating the silicone mold and the patterned feature; optionally D) etching the patterned feature; and optionally E) repeating steps A) to D) reusing the silicone mold.

### DETAILED DESCRIPTION

All amounts and ratios are by weight unless otherwise indicated. The following is a list of definitions, as used herein.

### DEFINITIONS

When introducing elements, the articles “a”, “an”, and “the” mean that one or more elements may be present.

The abbreviations have the following meanings: “cP” means centipoise, “CTE” means coefficient of thermal expansion, “mm” means millimeters, “nm” means nanometers, “PDMS” means polydimethylsiloxane, and “UV” means ultra-violet.

“Photoacid generator” means a compound that decomposes on exposure to light to generate an acid catalyst.

### Curable Epoxy Formulation

This invention relates to a curable epoxy formulation comprising:

(a) an epoxy-functional compound, and
(b) a photoacid generator.
The curable epoxy formulation may comprise 10 to 99.5% component (a) and 0.5 to 10% component (b).

### Component (a) Epoxy-Functional Compound

Component (a) may comprise an epoxy-functional alkoxysilane or an organic epoxy-functional compound. When an epoxy-functional alkoxysilane is used as component (a), the epoxy-functional alkoxysilane can have the formula R¹ₐSi(OR²)₍₄₋ₐ₎, where a is 1, 2, or 3, alternatively a is 1.

Each R¹ is independently a monovalent hydrocarbon group or epoxy-functional organic group with the proviso that an average of at least one R¹ per molecule is an epoxy-functional organic group. Epoxy-functional organic groups for R¹ are exemplified by epoxy, glycidoxypropyl and (epoxycyclohexyl)ethyl. Hydrocarbon groups for R¹ are exemplified by alkyl, such as methyl, ethyl, propyl and butyl.

Each R² is independently a hydrocarbon group. The hydrocarbon group may have 1 to 4 carbon atoms, alternatively 1 to 2 carbon atoms. R² may be an alkyl group. R² is exemplified by methyl, ethyl, propyl, and butyl.

Examples of suitable epoxy-functional alkoxysilanes include glycidoxypropyltrimethoxysilane, glycidoxypropyltriethoxysilane, (epoxycyclohexyl)ethyldimethoxysilane, (epoxycyclohexyl)ethyldiethoxysilane and combinations thereof. Alternatively, glycidoxypropyltrimethoxysilane may be used as component (a). When component (a) is an epoxy-functional alkoxysilane, the curable epoxy formulation may contain an amount of component (a) ranging from 10% to 90%.

Alternatively, component (a) may comprise (i) an epoxy-functional compound having two epoxy-functional groups per molecule, (ii) an epoxy-functional crosslinking agent having at least 3 epoxy-functional groups per molecule, or a combination thereof. Component (i) may comprise a diepoxyalkane, such as diepoxyoctane, a difunctional glycidyl ether, or a combination thereof.

### Difunctional Glycidyl Ether

Component (i) may be a difunctional glycidyl ether having the formula:

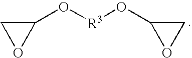

In the formula above, R³ is a divalent organic group. Suitable divalent organic groups include divalent hydrocarbon groups exemplified by alkylene groups such as ethylene, propylene, butylene, and hexylene. Alternatively R³ may be butylene. Examples of suitable glycidyl ethers include 1,4-butanediol glycidyl ether and glycerol diglycidyl ether. The amount of component (i) may range from 40% to 70% based on the weight of the composition.

Component (ii) the crosslinking agent may be a trifunctional glycidyl ether having the formula:

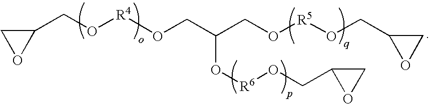

In the formula above, each R⁴, each R⁵, and each R⁶ are independently selected from divalent hydrocarbon groups. Suitable divalent hydrocarbon groups are exemplified by alkylene groups such as ethylene, propylene, butylene, and hexylene. Alternatively each R⁴, each R⁵, and each R⁶ may be ethylene. Subscripts o, p, and q have values sufficient to give the glycidyl ether a viscosity of 50 to 400 cP at 25° C., alternatively 100 to 300 cP, alternatively 200 cP. The amount of crosslinking agent may range from 1% to 10% based on the weight of the composition.

### Component (b) Photoacid Generator

Component (b) is a photoacid generator. The photoacid generator can be any photoacid generator capable of initiating cure (cross-linking) of the curable epoxy formulation upon exposure to radiation having a wavelength ranging from 150 to 800 nm. Suitable photoacid generators are known in the art and are commercially available. Exemplary photoacid generators include onium salts, such as diaryliodonium salts, iodonium salts containing [SbF₆]⁻ counterions, triarylsulfonium salts, dialkylphenacylsulfonium salts, dialkyl-4-hydroxyphenylsulfonium salts, and triaryl sulfonium hexafluoroantimonate salts. A description of these exemplary photoacid generators is given by Crivello, Adv. Polym. Sci. 62:1-48, Springer-Verlag (Berlin) 1984. Examples of suitable photoacid generators include (C₆H₅)₃S⁺SbF₆⁻ or (p-(CH₃)₃CC₆H₄)₃C⁻(SO₂CF₃)₃, both of which are commercially available from Minnesota Mining and Manufacturing Company, of Minnesota, U.S.A. Suitable iodonium salts and methods for their preparation are disclosed in U.S. Pat. No. 5,426,222 and U.S. Pat. No. 4,985,340.

Suitable onium salts include salts having a formula selected from R⁷₂I⁺MX_{z}—, R⁷₃S⁺MX_{z}—, R⁷₃Se⁺MX_{z}—, R⁷₄P⁺MX_{z}—, and R⁷₄N⁺MX_{z}—, wherein each R⁷ is independently hydrocarbyl or substituted hydrocarbyl having from 1 to 30 carbon atoms; M is an element selected from transition metals, rare earth metals, lanthanide metals, metalloids, phosphorus, and sulfur; X is a halo (e.g., chloro, bromo, iodo), and z has a value such that the product z (charge on X+oxidation number of M)=−1. Examples of substituents on the hydrocarbyl group include, but are not limited to, C₁ to C₈ alkoxy, C₁ to C₁₆ alkyl, nitro, chloro, bromo, cyano, carboxyl, mercapto, and heterocyclic aromatic groups, such as pyridyl, thiophenyl, and pyranyl. Examples of metals represented by M include, but are not limited to, transition metals, such as Fe, Ti, Zr, Sc, V, Cr, and Mn; lanthanide metals, such as Pr, and Nd; other metals, such as Cs, Sb, Sn, Bi, Al, Ga, and In; metalloids, such as B, and As; and P. The formula MX_{z}— represents a non-basic, non-nucleophilic anion. Examples of anions having the formula MX_{z}— include, but are not limited to, BF₄—, PF₆—, AsF₆—, SbF₆═, SbCl₆—, and SnCl₆—.

Examples of onium salts include, but are not limited to, bis-diaryliodonium salts, such as bis(dodecyl phenyl)iodonium hexafluoroarsenate, bis(dodecylphenyl)iodonium hexafluoroantimonate, and dialkylphenyliodonium hexafluoroantimonate.

Diaryliodonium salts are exemplified by diaryliodonium salts of sulfonic acids and diaryliodonium salts of boronic acids. Examples of diaryliodonium salts of sulfonic acids include, but are not limited to, diaryliodonium salts of perfluoroalkylsulfonic acids, such as diaryliodonium salts of perfluorobutanesulfonic acid, diaryliodonium salts of perfluoroethanesulfonic acid, diaryliodonium salts of perfluorooctanesulfonic acid, and diaryliodonium salts of trifluoromethanesulfonic acid; and diaryliodonium salts of aryl sulfonic acids, such as diaryliodonium salts of para-toluenesulfonic acid, diaryliodonium salts of dodecylbenzenesulfonic acid, diaryliodonium salts of benzenesulfonic acid, and diaryliodonium salts of 3-nitrobenzenesulfonic acid.

Examples of diaryliodonium salts of boronic acids include, but are not limited to, diaryliodonium salts of perhaloarylboronic acids. Examples of triarylsulfonium salts of boronic acids include, but are not limited to, triarylsulfonium salts of perhaloarylboronic acid. Diaryliodonium salts of boronic acids and triarylsulfonium salts of boronic acids are well known in the art, as exemplified in European Patent Application No. EP 0562922.

Triarylsulfonium salts are exemplified by triarylsulfonium salts of sulfonic acids and triarylsulfonium salts of boronic acids. Examples of triarylsulfonium salts of sulfonic acids include, but are not limited to, triarylsulfonium salts of perfluoroalkylsulfonic acids, such as triarylsulfonium salts of perfluorobutanesulfonic acid, triarylsulfonium salts of perfluoroethanesulfonic acid, triarylsulfonium salts of perfluorooctanesulfonic acid, and triarylsulfonium salts of trifluoromethanesulfonic acid; and triarylsulfonium salts of aryl sulfonic acids, such as triarylsulfonium salts of para-toluenesulfonic acid, triarylsulfonium salts of dodecylbenzenesulfonic acid, triarylsulfonium salts of benzenesulfonic acid, and triarylsulfonium salts of 3-nitrobenzenesulfonic acid.

Ingredient (b) can be a single photoacid generator or a combination comprising two or more different photoacid generator, each as described above. The amount of the photoacid generator may range from 0.01 to 5%, alternatively 0.1 to 2%, based on the weight of the curable epoxy formulation.

### Optional Components

The curable epoxy formulation may further comprise one or more optional components in addition to components (a) and (b). Examples of such optional components include, but are not limited to, (c) an antioxidant, (d) a fluorescent dye, (e) a reactive diluent, (f) a monofunctional (meth)acrylate, (g) a photosensitizer, (h) a wetting agent, (i) a silane, (j) a release agent, (k) a radical initiator, and a combination thereof.

### Component (c) Antioxidant

Component (c) is an antioxidant that may be optionally added to the curable epoxy formulation. The amount of component (c) may be up to 1% based on the weight of the curable epoxy formulation. Suitable antioxidants are known in the art and commercially available. Suitable antioxidants include phenolic antioxidants and combinations of phenolic antioxidants with stabilizers. Phenolic antioxidants include fully sterically hindered phenols and partially hindered phenols. Stabilizers include organophosphorous derivatives such as trivalent organophosphorous compound, phosphites, phosphonates, and a combination thereof; thiosynergists such as organosulfur compounds including sulfides, dialkyldithiocarbamate, dithiodipropionates, and a combination thereof; and sterically hindered amines such as tetramethyl-piperidine derivatives. Suitable antioxidants and stabilizers are disclosed in Zweifel, Hans, “Effect of Stabilization of Polypropylene During Processing and Its Influence on Long-Term Behavior under Thermal Stress,” Polymer Durability, Ciba-Geigy A G, Additives Division, CH-4002, Basel, Switzerland, American Chemical Society, vol. 25, pp. 375-396, 1996.

Suitable phenolic antioxidants include vitamin E and IRGANOX® 1010 also from Ciba Specialty Chemicals, Inc. IRGANOX® 1010 comprises pentaerythritol tetrakis(3-(3,5-di-t-butyl-4-hydroxyphenyl)propionate). The curable epoxy formulation may comprise 0 to 1% component (c).

### Component (d) Fluorescent Dye

Component (d) is a fluorescent dye that may optionally be added to the curable epoxy formulation. Examples of fluorescent dyes include but are not limited to rhodamine 6G,2,2′-(2,5 thiophenediyl)bis-[(tert)butylbenzoxazole] UVITEX OB from Ciba Specialty Chemicals, Inc. of Tarrytown, N.Y. 10591, U.S.A. The amount of component (d) used may be 0 to 1% based on the weight of curable epoxy formulation.

### Component (e) Reactive Diluent

Component (e) is a reactive diluent. The choice of component (e) is governed by many factors such as the solubility and miscibility of the components in the curable epoxy formulation, the method of using the curable epoxy formulation, and safety and environmental regulations. Examples of suitable reactive diluents include, but are not limited to, alcohols, maleic anhydrides, vinyl acetates, vinyl ester, vinyl ethers, fluoro alkyl vinyl ethers, vinyl pyrrolidones such as N-vinyl pyrrolidone, styrene, monofunctional epoxy compounds, and combinations thereof. Examples of suitable alcohols include ethanol, butanol, hexanol, decanol, and combinations thereof. Examples of suitable vinyl ethers include, but are not limited to butanediol divinyl ether, cyclohexanedimethanol divinyl ether, cyclohexanedimethanol monovinyl ether, cyclohexyl vinyl ether, diethyleneglycol divinyl ether, diethyleneglycol monovinyl ether, dodecyl vinyl ether, ethyl vinyl ether, hydroxybutyl vinyl ether, isobutyl vinyl ether, isopropyl vinyl ether, n-butyl vinyl ether, n-propyl vinyl ether, octadecyl vinyl ether, triethyleneglycol divinyl ether, and combinations thereof. Vinyl ethers are known in the art and commercially available from BASF AG of Germany.

Monofunctional epoxy compounds useful as the reactive diluent that may have the formula

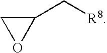

In the formula above, R⁸ is a monovalent hydrocarbon group. Suitable monovalent hydrocarbon groups are exemplified by alkyl groups such as methyl, ethyl, propyl, butyl, pentyl, hexyl, heptyl, and octyl. Alternatively, R⁸ is propyl or pentyl. Examples of monofunctional epoxy compounds for component (e) include but are not limited to epoxyhexane. The amount of component (e) may range from 0 to 1% based on the weight of curable epoxy formulation.

### Component (f) Monofunctional (Meth)acrylate

Component (f) is a monofunctional (meth)acrylate. Although curable epoxy formulations generally have lower shrinkage and better resolution than curable (meth)acrylate formulations in soft lithography techniques, component (f) may be added to the curable epoxy formulation in an amount ranging from 0 to 50% based on the weight of the curable epoxy formulation without impairing the properties of features prepared using the curable epoxy formulation.

Monofunctional (meth)acrylates may have the general formula:

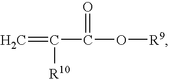

where R¹⁰ is a hydrogen atom or a methyl group and R⁹ is a monovalent organic group free of fluorine atoms. Monovalent organic groups for R⁹ may be linear, branched, or cyclic. Examples of monovalent organic groups for R⁹ include, but are not limited to, monovalent hydrocarbon groups. Monovalent hydrocarbon groups include, but are not limited to, alkyl groups exemplified by methyl, ethyl, propyl, butyl, pentyl, hexyl, heptyl, and ethylhexyl; alkenyl groups exemplified by vinyl and allyl; cyclic hydrocarbon groups exemplified by cyclopentyl, cyclohexyl, and isobornyl. Examples of monovalent organic groups for R⁹ further include, but are not limited to, monovalent hydrocarbonoxy functional organic groups such as alkoxy groups exemplified by methoxy, ethoxy, propoxy, and butoxy; alkoxyalkyl such as methoxymethyl, ethoxymethyl, methoxyethyl, and ethoxyethyl; alkoxyalkoxyalkyl such as methoxymethoxymethyl, ethoxyethoxymethyl, methoxymethoxyethyl, and ethoxyethoxyethyl.

Examples of monofunctional (meth)acrylates include, but are not limited to, 2(2-ethoxyethoxy)ethyl acrylate, 2-acryloylethyl-2-hydroxyethyl-o-phthalate, 2-ethoxyethoxyethyl acrylate, 2-ethoxyethyl acrylate, 2-ethoxyethylmethacrylate, 2-ethylhexyl methacrylate, 2-hydroxyethyl acrylate, 2-hydroxyethyl methacrylate, 2-hydroxypropyl acrylate, 2-hydroxypropyl methacrylate, 2-methoxyethyl acrylate, 2-phenoxyethyl acrylate, 4-hydroxybutyl acrylate, acrylic acid, alkoxylated lauryl acrylate, alkoxylated phenol acrylate, alkoxylated tetrahydrofurfuryl acrylate, allyl methacrylate, benzyl acrylate, benzyl methacrylate, beta carboxy ethyl acrylate, butyl diglycol methacrylate, caprolactone acrylate, cetyl acrylate, cyclic trimethylolpropane formal acrylate, cyclohexyl acrylate, cyclohexyl methacrylate, cyclohexylmethacrylate, dicyclopentadienyl methacrylate, diethylaminoethyl methacrylate, dimethyl aminoethyl acrylate, dimethyl aminoethyl methacrylate, dimethyl aminoethyl methacrylate methylchloride salt, EO7 ethyl capped methacrylate, epoxy acrylate, ethoxyethyl methacrylate, ethoxylated (10) hydroxyethyl methacrylate, ethoxylated (2) hydroxyethyl methacrylate, ethoxylated (5) hydroxyethyl methacrylate, ethoxylated phenol acrylate, ethyl methacrylate, ethyl triglycol methacrylate, glycidyl methacrylate, hydroxyethyl acrylate, isobornyl acrylate, isobornyl methacrylate, isobutyl acrylate, isobutyl methacrylate, isodecyl acrylate, isooctyl acrylate, lauryl acrylate, lauryl methacrylate, lauryl tridecyl acrylate, methacrylic acid, methacrylonitrile, methoxy polyethylene glycol (350) monoacrylate E06, methyl methacrylate, n-butyl methacrylate, octyl decyl acrylate, polypropylene glycol monomethacrylate, propoxylated (2) allyl methacrylate, stearyl acrylate, stearyl methacrylate, tert-butyl amino methacrylate, tert-butyl acrylate, tert-butyl methacrylate, tetrahydrofurfuryl acrylate, tetrahydrofurfuryl methacrylate, tetrahydrofuryl acrylate, tetrahydrofuryl methacrylate, tetrahydrogenfuranmethacrylate, tridecyl acrylate, tridecyl methacrylate, trimethylcyclohexylmethacrylate, urethane acrylate, and combinations thereof.

### Component (g) Photosensitizer

Component (g) photosensitizer that may optionally be added to the curable epoxy formulation in addition to or instead of component (b). Component (g) changes the wavelength of radiation required to cure the curable epoxy formulation. One skilled in the art would be able to select appropriate photosensitizers without undue experimentation based on the specific epoxy-functional compounds selected for component (a). Component (g) may comprise a ketone, coumarin dye, xanthene dye, acridine dye, thiazole dye, thiazine dye, oxazine dye, azine dye, aminoketone dye, porphyrin, aromatic polycyclic hydrocarbon, p-substituted aminostyryl ketone compound, aminotriaryl methane, merocyanine, squarylium dye, pyridinium dye, or combination thereof. Examples of component (g) include, but are not limited to rose bengal, camphorquinohe, glyoxal, biacetyl, 3,3,6,6-tetramethylcyclohexanedione, 3,3,7,7-tetramethyl-1,2-cycloheptanedione, 3,3,8,8-tetramethyl-1,2-cyclooctanedione, 3,3,18,18-tetramethyl-1,2-cyclooctadecanedione, dipivaloyl, benzil, furil, hydroxybenzil, 2,3-butanedione, 2,3-pentanedione, 2,3-hexanedione, 3,4-hexanedione, 2,3-heptanedione, 3,4-heptanedione, 2,3-octanedione, 4,5-octanedione, 1,2-cyclohexanedione, 2-isopropylthioxanthone, benzophenone, or combination thereof. Alternatively, component (g) may comprise 2-isopropylthioxanthone or benzophenone or a combination thereof. The amount of component (g) used may be 0 to 2%, alternatively 0.01 to 2%, and alternatively 0.05 to 0.5% based on the weight of curable epoxy formulation.

### Component (h) Wetting Agent

Component (h) is a wetting agent that may optionally be added to the curable epoxy formulation. Examples of component (h) include, but are not limited to silicone diacrylate, which is commercially available as EBECRYL® 350 from UCB Chemicals of Belgium; silicone hexaacrylate, which is commercially available as EBECRYL® 1360 also from UCB Chemicals; polyether modified polydimethylsiloxanes, which are commercially available as BYK®-307, BYK®-UV 3510, and BYK®-333 from BYK-Chemie GmbH of Germany; polyether modified acryl functional polydimethylsiloxane, which is commercially available as BYK®-UV 3500, also from BYK-Chemie GmbH; and polyacrylic copolymer, which is commercially available as BYK®-381 also from BYK-Chemie GmbH; crosslinkable silicone acrylates, which are commercially available as Rad 2100, Rad 2500, Rad 2600, and Rad 2700 from Tego Chemie Service GmbH of Germany; and crosslinkable silicone polyether acrylates, which are commercially available as Rad 2200 N, Rad 2250, and Rad 2300 also from Tego Chemie Service GmbH. The amount of component (h) used may be 0 to 1% based on the weight of curable epoxy formulation.

### Component (i) Silane

Component (i) is an silane that may optionally be added to the curable epoxy formulation. Examples of component (i) include, but are not limited to alkoxysilanes such as methacryloxypropyltriethoxysilane, methacryloxypropyltrimethoxysilane, tetraethoxysilane, tetramethoxysilane, vinyltriethoxysilane, vinyltrimethoxysilane, and combinations thereof. The amount of component (i) used may be 0 to 2% based on the weight of curable epoxy formulation. When optional component (i) is present in the curable epoxy formulation and component (a) comprises an epoxy-functional alkoxysilane, optional component (i) differs from component (a).

### Component (j) Release Agent

Component (j) is a release agent that may optionally be added to the curable epoxy formulation to aid release of a feature prepared by curing the curable epoxy formulation from a mold in the method described below. The release agent may comprise a fluorofunctional alcohol. The amount of release agent in the curable epoxy formulation may range from 0 to 5 percent based on the weight of the curable epoxy formulation.

### Component (k) Radical Initiator

Component (k) is a radical initiator that may optionally be used in addition to, or instead of, a portion of component (b). The radical initiator may be an organometallic salt of the formula [((L¹)(L²)M_{b}(L³)(L⁴)]^{+e}X_{f}, where M represents a metal atom selected from the elements of groups IVB, VB, VIB, VIIB, and VIIIB of the Periodic Table; with the proviso that the formula represents an organometallic salt having an mono- or bimetallic cation. L¹ represents, none, 1, 2, or 3 ligands contributing pi-electrons that can be the same or different ligand selected from substituted and unsubstituted acyclic and cyclic unsaturated compounds and groups and substituted and unsubstituted carbocyclic aromatic and heterocyclic aromatic compounds, each capable of contributing 2 to 12 pi-electrons to the valence shell of M. L² represents none, or 1 to 6 ligands contributing an even number of sigma-electrons that can be the same or different, selected from mono-, di-, and tri-dentate ligands each donating 2, 4, or 6 sigma-electrons to the valence shell of M. L³ represents none, 1 or 2 bridging ligands contributing pi-electrons that can be the same or different ligand selected from substituted and unsubstituted acyclic ad cyclic unsaturated compounds and groups and substituted and unsubstituted carbocyclic aromatic and heterocyclic aromatic compounds, each capable of acting as a bridging ligand contributing 4 to 24 pi-electrons to the valence shells of two metal atoms M, simultaneously. L⁴ represents none, 1, 2, or 3 bridging ligands contributing an even number of sigma electrons that can be the same or different, selected from mono-, di-, and tri-dentate ligands each donating 2, 4, or 6 sigma-electrons to the valence shells of two M atoms simultaneously, with the proviso that the total electronic charge contributed to M by the ligands L¹, L², L³, and L⁴ plus the product ionic charge on M with b results in a residual positive charge of e to the cation. The subscript b is an integer having a value of 1 or 2, and the subscript e is an integer having a value of 1 or 2, the residual electrical charge of the cation. X is an anion selected from organic sulfonate anions and halogen-containing complex anions of a metal or metalloid. The subscript f is an integer with a value of 1 or 2, the number of anions required to neutralize the positive charge e on the cation. Examples of suitable radical initiators are known in the art and are disclosed, for example, in U.S. Pat. No. 4,985,340.

The curable epoxy formulation suitable for use in this invention is curable by exposure to UV radiation or a combination of UV radiation and heat. In general, viscosity of the curable epoxy formulation is less than 400 cP at 25° C. Alternatively, viscosity may range from 1 cP to 400 cP at 25° C. Alternatively, viscosity may range from 5 to 400 cP at 25° C., alternatively 5 to 20 cP at 25° C., alternatively 1 to 10 cP at 25° C.

### Molding Method

This invention relates to a molding method. The method comprises:

I) filling a silicone mold having a patterned surface with a curable epoxy formulation having a viscosity less than 400 centiPoise at 25° C.;

II) curing the curable epoxy formulation to form a patterned feature;

IIII) separating the silicone mold and the patterned feature;

optionally IV) etching the patterned feature;

optionally V) cleaning the silicone mold; and

optionally VI) repeating steps I) to V) reusing the silicone mold. The method may optionally further comprise before step I),

i) casting a curable silicone composition against a master,

ii) curing the curable silicone composition to form a silicone mold,

iii) separating the master and the silicone mold,

The master may have a patterned relief structure on its surface. The resulting product of step iii) is a silicone mold having a patterned surface. This method may provide a silicone mold having a mold misalignment <1%.

Step i) may be performed by any convenient means, such as forming a master pattern in a photoresist on a substrate such as glass and pouring the curable silicone composition into the master. Alternatively step i) may be performed by forming a mold housing from a casing accommodating a master on an internal face and a back plane on an opposing face. The master may be a substrate such as glass with a patterned photoresist in the negative pattern desired for the silicone mold patterned surface. The master and backplane may be held in place on opposing faces inside the mold housing. After the master and backplane are positioned in the housing, a degassed curable silicone composition may be injected into the mold. Suitable methods for performing step i) are known, for example see U.S. Patent Publication No. 2002/0130444 corresponding to U.S. patent application Ser. No. 09/809,440 at paragraphs [0015] and [0016].

The curable silicone composition useful in step i) may be prepared by combining ingredients comprising:

(A) 25 to 90%, based on total weight of the curable silicone composition, of a polyorganosiloxane fluid having an average of at least two unsaturated organic groups per molecule,

(B) 0.4 to 20%, based on total weight of the curable silicone composition, of an organohydrogenpolysiloxane having an average of at least two silicon-bonded hydrogen atoms per molecule,

(C) a hydrosilylation catalyst in an amount sufficient to provide 0.1 to 1000 ppm of a platinum group metal based on total weight of the curable silicone composition, and

(D) 0.0025 to 0.05%, based on total weight of the curable silicone composition, of an inhibitor. The curable silicone composition may further comprise a mold release agent, such as an unreactive fluorosilicone.

Curable silicone compositions are known in the art and are commercially available. Examples of curable silicone compositions that may be used in the method described above is SYLGARD® 182, 184, or 186, which are commercially available from Dow Corning Corporation of Midland, Mich., U.S.A.

Step ii) may be performed by exposing the curable silicone composition to ambient conditions (e.g., 20° C. to 30° C.) for an extended period of time, for example a period of time greater than or equal to 2 days, alternatively 2 to 5 days, optionally followed by heating the curable silicone composition for a short period of time, e.g., heating at a temperature ranging from 50° C. to 120° C., alternatively 50° C. to 60° C. for 30 minutes to 24 hours, alternatively 30 minutes to 60 minutes. Known methods for curing the curable silicone composition may be employed, for example, see U.S. Patent Publication No. 2002/0130444 corresponding to U.S. patent application Ser. No. 09/809,440 at paragraph [0016].

The product of step iii) is a silicone mold that may be easily released from a variety of patterned features, including but not limited to epoxy patterned features. The silicone mold may have a surface energy of 20 dyne/cm. The silicone mold may be translucent or transparent, alternatively transparent. The silicone mold may be flexible and elastomeric.

Step I) may be performed by various methods. For example, step I) may be performed by contacting the patterned surface of the silicone mold with a substrate, such that patterned structures in the patterned surface form a network of empty channels. When the curable epoxy formulation is placed at open ends of the network, capillary action fills the channels with the curable epoxy formulation. Alternatively, the curable epoxy formulation may be applied to the patterned surface before contacting the patterned surface with a substrate. Alternatively, the curable epoxy formulation may be applied to a surface of a substrate before the patterned surface is contacted with the substrate. Alternatively, a mold release agent may be applied to the silicone mold before the curable epoxy formulation is filled in the silicone mold. For example, a fluorofunctional surfactant may be applied to the silicone mold before the curable epoxy formulation is filled in the silicone mold.

Step II) may be performed by exposing the curable epoxy formulation to UV radiation, by heating the curable epoxy formulation, or a combination thereof. The exposure dose depends on the specific curable epoxy formulation selected and the configuration of the mold, however, exposure may be 100 milliJoule to 4000 milliJoule. The temperature to which the composition is heated also depends on the specific curable epoxy formulation selected, however the temperature may be 50° C. to 200° C., alternatively 100° C. to 120° C.

Step III) may be performed by any convenient means such as removing the silicone mold from the patterned feature by, for example, manually peeling the silicone mold off the patterned feature or automatically using, for example, a micromolding tool from SUSS MicroTec, Inc. of Indianapolis, Ind. 46204, U.S.A.

Step IV) may be performed by techniques known in the art, for example, reactive ion etching or wet etching. In some lithography techniques, such as imprint molding, solid may form on a substrate in undesired areas during step B). Etching may be used to remove this excess solid, or to remove layers under the excess solid, or both.

Step V) may be performed by any convenient technique, such as rinsing with a solvent.

This invention may be used in various lithography techniques. Examples of such lithography techniques include, but are not limited to, imprint molding, step and flash imprint molding, solvent assisted micromolding (SAMIM), microtransfer molding, and micromolding in capillaries (MIMIC).

This invention may be used for imprint molding. In this lithography technique, the curable epoxy formulation is applied on a surface of a substrate. The patterned surface of the silicone mold is brought into contact with the surface of the substrate, thereby distributing the curable epoxy formulation in the silicone mold. The curable epoxy formulation is then cured to a solid, and the silicone mold is removed. Imprint molding may be used to prepare, for example, photodetectors and quantum-wire, quantum-dot, and ring transistors.

This invention may also be used in SAMIM. In this lithography technique, the curable epoxy formulation is applied on a surface of a substrate. A patterned surface of a silicone mold is wetted with a solvent and is brought into contact with the surface of the curable epoxy formulation. The choice of solvent depends on various factors including the specific silicone mold and curable epoxy formulation selected; the solvent should rapidly dissolve or swell the surface of the curable epoxy formulation but not swell the silicone mold. The curable epoxy formulation is then cured to a solid, and the silicone mold is removed.

This invention may be used in microtransfer molding, in which a curable epoxy formulation described above is applied to the patterned surface of the silicone mold. If any excess curable epoxy formulation is present, it may be removed, for example, by scraping with a flat block or by blowing with stream of inert gas. The resulting filled mold may be contacted with a substrate. The curable epoxy formulation is then cured by heating, exposure to UV radiation, or a combination thereof. When the curable epoxy formulation has cured to a solid, the mold may be peeled away to leave a patterned feature on the substrate. Microtransfer molding may be used to fabricate, for example, optical waveguides, couplers, and interferometers.

This invention may also be used for MIMIC. In this lithography technique, the patterned surface of the silicone mold is contacted with a surface of a substrate. The patterned structures in the silicone mold form a network of empty channels. When the curable epoxy formulation described above is placed at open ends of the network, capillary action fills the channels with the curable epoxy formulation. The curable epoxy formulation is then cured to a solid, and the silicone mold is removed.

### Uses of the Invention

The method and curable epoxy formulations described herein may be used to prepare a resist layer or a permanent layer in a lithography technique such as imprint molding, step and flash imprint molding, solvent assisted micromolding, microtransfer molding, and micromolding in capillaries. The methods, molds, and curable epoxy formulations compositions described herein may be used in lithography techniques such as those described in U.S. Pat. Nos. 6,334,960; 6,719,915; and 6,696,220 and in U.S. Patent Publications U.S. 2004/0141163 A1; U.S. 2004/0170771 A1; U.S. 2004/0168586 A1; U.S. 2002/0093122 A1; and U.S. 2002/0094496 A1. This invention may be used during fabrication of various devices, including but not limited to light emitting diodes, including but not limited to organic light emitting diodes; transistors such as organic field effect transistors and thin film transistors; display devices such as plasma displays and liquid crystal displays, photodetectors, optical waveguides, couplers, and interferometers.

### EXAMPLES

These examples are intended to illustrate the invention to one of ordinary skill in the art and should not be interpreted as limiting the scope of the invention set forth in the claims.

### Reference Example 1

### PDMS Mold Preparation and Evaluation

SYLGARD® 184 was used to prepare molds in this example.

Molds of 300 mm×200 mm in length are used to model 15″ display panels. The molds are made against a master made from a patterned photoresist to provide alignment marks. Misalignment is measured as follows. The mold is cured on the master for 2-5 days at room temperature. After curing, the mold is detached from the master and re-mounted onto the master with the alignment marks matched and the shifts of feature lines measured using an optical microscope.

The mold is used in an in-plane printing process to make high fidelity patterns of epoxy polymer films. The patterns are transferred by UV irradiation. The mold may be released from the cured molded film.

### Example 1

### Curable Epoxy Formulation

Curable epoxy formulations were prepared by mixing the components in the amounts in the table shown below.

| | Parts by Weight | Parts by Weight |
|---|---|---|
| Component | in Sample 1 | in Sample 2 |
| Diepoxyoctane | 60 | 50 |
| Epoxyhexane | 29 | 39 |
| 1,4-Butanediol diglycidyl | 5 | 5 |
| ether | | |
| Triaryl sulfonium | 6 | 6 |
| hexafluoroantimonate salts | | |

The curable epoxy formulation in sample 1 has viscosity of 6 cP at 25° C. A patterned feature having less than 5 micrometer resolution was produced by curing this curable epoxy formulation in the method of reference example 1.

### Example 2

### Curable Epoxy Formulation

Curable epoxy formulations were prepared by mixing the components in the amounts in the table shown below.

| | Parts by Weight | Parts by Weight |
|---|---|---|
| Component | in Sample 3 | in Sample 4 |
| Diepoxyoctane | 60 | 50 |
| Epoxybutane | 29 | 39 |
| 1,4-Butanediol diglycidyl | 5 | 5 |
| ether | | |
| Triaryl sulfonium | 6 | 6 |
| hexafluoroantimonate salts | | |

### Example 3

### Curable Epoxy Formulation

A curable epoxy formulation was prepared by mixing the components in the amounts in the table shown below.

| Component | Parts by Weight in Sample 5 |
|---|---|
| Glycerol diglycidyl ether | 48 |
| Epoxyhexane | 47 |
| Triarylsulfonium | 5 |
| hexafluoroantimonate salts | |

The curable epoxy formulation had viscosity of 3.5 cP at 25° C. A patterned feature is produced by curing this curable epoxy formulation in the method of reference example 1.

### Example 4

### Curable Epoxy Formulation

A curable epoxy formulation was prepared by mixing the components in the amounts in the table shown below. Epodil 750 is 1,4-butanediol diglycidyl ether, which is commercially available from Air Products and Chemicals, Inc. of Allentown, Pa., U.S.A.

| Component | Parts by Weight in Sample 6 |
|---|---|
| Epodil 750 | 63 |
| Epoxyhexane | 33 |
| Triarylsulfonium | 4 |
| hexafluoroantimonate salts | |

The curable epoxy formulation had viscosity of 4.0 cP at 25° C. A patterned feature was produced by curing this curable epoxy formulation in the method of reference example 1.

### Example 5

### Curable Epoxy Formulation

A curable epoxy formulation was prepared by mixing the components in the amounts in the table shown below.

| Component | Parts by Weight in Sample 7 |
|---|---|
| Epodil 750 | 50 |
| Diepoxyoctane | 20 |
| Epoxyhexane | 24 |
| Triarylsulfonium | 6 |
| hexafluoroantimonate salts | |

The curable epoxy formulation had viscosity of 3.6 cP at 25° C. A patterned feature was produced by curing this curable epoxy formulation in the method of reference example 1.

### Example 6

### Curable Epoxy Formulation

Curable epoxy formulations were prepared by mixing the components in the amounts in the table shown below.

| | Parts by Weight in | Parts by Weight in |
|---|---|---|
| Component | Sample 8 | Sample 9 |
| Epodil 750 | 48 | 63 |
| Epoxybutane | 47 | 33 |
| Triarylsulfonium | 5 | 4 |
| hexafluoroantimonate salts | | |

### Example 7

### Curable Epoxy Formulation

A curable epoxy formulation was prepared by mixing the components in the amounts in the table shown below.

| Component | Parts by Weight in Sample 10 |
|---|---|
| Epodil 750 | 50 |
| Epoxybutane | 24 |
| Diepoxyoctane | 20 |
| Triarylsulfonium | 6 |
| hexafluoroantimonate salts | |

### Example 8

### Curable Epoxy Formulation

A curable epoxy formulation was prepared by mixing the components in the amounts in the table shown below.

| Component | Parts by Weight in Sample 11 |
|---|---|
| Epodil 750 | 57 |
| Epoxyhexane | 10 |
| Diepoxyoctane | 27 |
| Triarylsulfonium | 6 |
| hexafluoroantimonate salts | |

### Example 9

### Curable Epoxy Formulation

A curable epoxy formulation was prepared by mixing the components in the amounts in the table shown below.

| Component | Parts by Weight in Sample 12 |
|---|---|
| Epodil 750 | 57 |
| Epoxyhexane | 17 |
| Diepoxyhexane | 20 |
| Triarylsulfonium | 6 |
| hexafluoroantimonate salts | |

1. A method comprising:
I) filling a silicone mold with a curable epoxy formulation having a viscosity less than 400 centiPoise at 25° C.,
II) curing the curable epoxy formulation to form a patterned feature,
III) separating the silicone mold and the patterned feature,
optionally IV) etching the patterned feature,
optionally V) cleaning the silicone mold, and
optionally VI) repeating steps I) to V) reusing the silicone mold.

2. The method of claim 1, further comprising before step I):
i) casting a curable silicone composition against a master,
ii) curing the curable silicone composition to form the silicone mold having a patterned surface, and
iii) separating the master and the silicone mold; where the curable silicone composition is prepared by combining ingredients comprising:
(A) 25 to 90%, based on total weight of the curable silicone composition, of a polyorganosiloxane fluid having an average of at least two unsaturated organic groups per molecule,
(B) 0.4 to 20%, based on total weight of the curable silicone composition, of an organohydrogenpolysiloxane having an average of at least two silicon-bonded hydrogen atoms per molecule,
(C) a hydrosilylation catalyst in an amount sufficient to provide 0.1 to 1000 ppm of a platinum group metal based on total weight of the curable silicone composition,
(D) 0.0025 to 0.05%, based on total weight of the curable silicone composition, of an inhibitor, and
optionally (E) a mold release agent.

3. The method of claim 1, where the curable epoxy formulation comprises:
(a) an epoxy-functional compound, and
(b) a photoacid generator, a photosensitizer, or a combination thereof.

4. The method of claim 3, where component (a) comprises an epoxy-functional alkoxysilane having formula R¹ₐSi(OR²)₍₄₋ₐ₎, where a is 1, 2, or 3, each R¹ is independently a monovalent hydrocarbon group or an epoxy-functional organic group with the proviso that an average of at least one R¹ per molecule is an epoxy-functional organic group, and each R² is independently a hydrocarbon group.

5. The method of claim 3, where component (a) comprises glycidoxytrimethoxysilane, glycidoxypropyltrimethoxysilane, glycidoxypropyltriethoxysilane, (epoxycyclohexyl)ethyldimethoxysilane, (epoxycyclohexyl)ethyldiethoxysilane, or a combination thereof.

6. The method of claim 3, where component (a) comprises (i) an epoxy-functional compound having two epoxy-functional groups per molecule, (ii) an epoxy-functional crosslinking agent, or a combination thereof.

7. The method of claim 5, where component (i) comprises an epoxy-functional alkane, a difunctional glycidyl ether, or a combination thereof.

8. The method of claim 7, where component (i) comprises a difunctional glycidyl ether of formula: 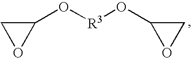
where R³ is a divalent organic group.

9. The method of claim 6, where component (ii) comprises a trifunctional glycidyl ether of formula: 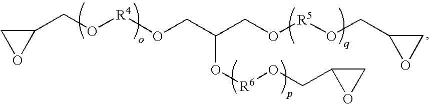
where each R⁴, each R⁵, and each R⁶ are independently selected from divalent hydrocarbon groups, and subscripts o, p, and q have values sufficient to give the ether a viscosity of 50 to 400 centiPoise at 25° C.

10. The method of claim 3, where component (b) is selected from the group consisting of diaryliodonium salts, iodonium salts containing [SbF₆]⁻ counterions, triarylsulfonium salts, dialkylphenacylsulfonium salts, dialkyl-4-hydroxyphenylsulfonium salts, and triaryl sulfonium hexafluoroantimonate salts.

11. The method of claim 3, where the curable epoxy formulation further comprises one or more components selected from the group consisting of (c) an antioxidant, (d) a fluorescent dye, (e) a reactive diluent, (f) a monofunctional (meth)acrylate, (h) a wetting agent, (i) a silane, (j) a release agent, (k) a radical initiator, and a combination thereof.

12. The method of claim 11, where the reactive diluent is present and comprises a monofunctional epoxy compound of formula 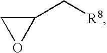
where R⁸ is a monovalent hydrocarbon group.

13. The method of claim 1, where the method is used in a lithography technique selected from the group consisting of: imprint molding, step and flash imprint molding, solvent assisted micromolding, microtransfer molding, and micromolding in capillaries.

14. A patterned feature prepared by the method of claim 13.

15. The method of claim 1 used in preparation of a device selected from the group consisting of a display device, a photodetector, a transistor, an optical waveguide, a coupler, and an interferometer, and a light emitting diode.

16. (canceled)

17. (canceled)

18. (canceled)

19. (canceled)
